(19) United States
(12) Patent Application Publication
(10) Pub. No.: US 2009/0278275 A1
(43) Pub. Date: Nov. 12, 2009

(54) Apparatus and Method for Forming Ceramic Products

(75) Inventor: Eugenio Morandi, Sassuolo (IT)

Correspondence Address: LAUBSCHER & LAUBSCHER, P.C., 1160 SPA ROAD, SUITE 2B, ANNAPOLIS, MD, 21403, US

(73) Assignee: OFFICINE MORANDI S.R.L., Sassuolo, MO (IT)

(21) Appl. No.: 12/374,245

(22) PCT Filed: May 23, 2007
(86) PCT No.: PCT/IB07/01332

§ 371 Date: Jan. 16, 2009

(30) Foreign Application Priority Data
Jul. 18, 2006 (IT) MO2006A000233

(51) Int. Cl. B28B 1/26

(52) U.S. Cl. 264/87; 264/86; 425/85

(57) ABSTRACT

A porous mold is provided for forming ceramic products from a ceramic fluid mixture formed of a suspension of ceramic material in a liquid. A suction device is arranged for extracting or withdrawing at least part of the liquid through the porous mold. An actuator reciprocally displaces the first and second half-molds of the porous mold to form a chamber and to vary the volume of the chamber. A method for forming ceramic products includes the steps of pouring in a porous mold a ceramic fluid mixture formed of a suspension of ceramic material in a liquid, extracting at least part of the liquid through the porous mold and pressing the ceramic fluid mixture by reciprocally moving first and second half-molds of the porous mold.

This application is a continuation of PCT International Application No. PCT/IB2007/001332 filed May 23, 2007. PCT/IB2007/001332 claims priority to IT Application No. MO2006A000233 filed Jul. 18, 2006. The entire contents of these applications are incorporated herein by reference.

### BACKGROUND OF THE INVENTION

The invention relates to an apparatus and a method for forming ceramic products, in particular tiles or plates, obtained from a ceramic fluid mixture.

Machines are known for manufacturing ceramic products from a ceramic fluid mixture, in particular sanitary ware, the machines being provided with a porous mold.

The ceramic fluid mixture is formed of a suspension of particles of ceramic material in a liquid.

The porous mold is provided with pores having sizes such as to enable the passage of the liquid, as well as gas, but prevent the passage of the particles of ceramic material.

The sanitary ware is obtained by injecting the ceramic fluid mixture in a closed chamber defined at the interior of the porous mold.

During the injection of the ceramic fluid mixture, a suction device generates a depression at the interior of the porous mold and draws or extracts a portion of the liquid and gases present at the interior of the closed chamber.

The evacuation of the liquid and gases is due to the combined action of the overpressure generated at the interior of the closed chamber by an injector device that injects the ceramic fluid mixture under pressure and the depression generated at the exterior of the closed chamber by the suction device.

The injector device continues to inject the ceramic fluid mixture, while the suction device is maintained at work, so that further ceramic fluid mixture—introduced successively into the closed chamber—compensates for the portion of liquid that was removed through the porous mold.

In a first step of the injection operation, the ceramic fluid mixture introduced into the closed chamber comprises a high percentage of liquid and a moderate percentage of solid. The ceramic fluid mixture is thus provided with high flowability and is distributed substantially uniformly along the interior of the closed chamber.

The ceramic fluid mixture is subjected to a substantially uniform pressure.

Consequently, the liquid is absorbed almost uniformly through the porous mold, i.e. the absorption is equal both in regions of the porous mold arranged near an injection nozzle of the ceramic fluid mixture and in regions of the porous mold set apart from the injection nozzle.

Successively, when a significant part of the liquid has already been removed through the porous mold, the ceramic fluid material is partially compacted and thus has a very limited flowability.

The further ceramic mixture that was lastly injected thus can not be distributed uniformly at the interior of the closed chamber, but is concentrated near the injection nozzle.

Consequently, the water present in the most recently injected ceramic mixture is not absorbed uniformly through the whole surface of the porous mold, but is absorbed only from the regions of the porous mold closer to the injection nozzle. Furthermore, part of the liquid tends not to be evacuated and remains at the interior of the closed chamber.

A drawback of the machines for producing sanitary ware disclosed above is that, during drying and firing, the portions of the ceramic products closer to the injection nozzle lose an amount of liquid greater than the portions of the products more distant from the injection nozzle. As a consequence, cracks may be formed such as to compromise the quality of the sanitary ware and that may cause failure of the sanitary ware.

The molds disclosed above further exhibit limits when used for obtaining plates or tiles.

Accordingly, it is difficult to homogeneously fill a closed chamber of large dimensions and limited depth by injection of a ceramic fluid mixture.

This drawback is more significant in the production of ceramic products having high mechanical performances, which ceramic products, being obtained from ceramic fluid mixtures containing hard materials, are less viscous and thus more difficult to be uniformly distributed along the interior of the closed chamber. The hard materials, in fact, being less plastic, less easily adapt to the variations of shape caused by the different percentage of liquid.

In order for a tile to be formed with streaks or stripes to look like natural stones, predetermined amounts of ceramic materials of different colors have to be distributed at the interior of the mold. These materials mutually permeate so as to provide a desired ornamental pattern extending three dimensionally.

In practice, the ceramic fluid mixtures may be introduced by injection into the mold at desired positions in order to obtain the above mentioned ornamental pattern only by providing a mold with a plurality of injection nozzles arranged at suitable regions about the perimeter of the mold.

This results in remarkable disadvantages.

On the one hand, it is necessary to provide a dedicated mold—i.e. a mold having injecting nozzles arranged at well defined positions—for every decorating pattern to be obtained, at extremely high costs.

Furthermore, all of the ceramic products obtained with a certain mold would exhibit substantially the same ornamental pattern, in contrast with the market requirement for different ornamental patterns of the products of the same type, in order to mimic natural materials.

Eventually, the ceramic fluid mixtures, during introduction into the mold, partially mix with each other, and in theory alter the ornamental pattern.

### SUMMARY OF THE INVENTION

An object of the invention is to improve the apparatuses and the methods known for forming ceramic products, such as tiles or plates obtained from a ceramic fluid mixture.

Another object is to prevent crack activating regions which may be present in ceramic products obtained from a fluid ceramic material, such crack activating regions being capable of damaging the products during firing.

A further object is to provide an apparatus for forming ceramic products obtained from a ceramic material that enables the ceramic products to be decorated during forming.

In a first aspect of the invention, an apparatus is provided, comprising a porous mold assembly for forming ceramic products from a ceramic fluid mixture comprising a suspension of ceramic material in a liquid, and a suction assembly for drawing or extracting at least part of the liquid through the porous mold assembly, the porous mold assembly comprising a first half-mold and a second half-mold. The apparatus further comprises a moving device for reciprocally moving or displacing the first half-mold and the second half-mold for forming, between the first half-mold and the second half-mold a chamber and for varying the volume of the chamber.

In a second aspect of the invention, a method is provided for obtaining ceramic products. A ceramic fluid mixture comprising a suspension of ceramic material in a liquid is poured in a porous mold assembly. At least part of the liquid is withdrawn through the porous mold assembly. The ceramic fluid mixture is compressed by reciprocally moving a first half-mold and a second half-mold of the porous mold assembly.

The apparatus and the method according to these aspects of the invention provide, consequently, not only a relative motion between the first half-mold and the second half-mold for forming a closed chamber, but also a relative motion between the first half-mold and the second half-mold for varying the volume of the closed chamber.

The suspension of ceramic material in a liquid that forms a ceramic fluid mixture is poured into the porous mold assembly when the first half-mold is still spaced apart from the second half-mold and does not define the closed chamber.

After the first half-mold and the second half-mold are brought into mutual contact by the moving device in order to define the closed chamber, the suction device extracts part of the liquid present in the interior of the closed chamber.

The volume of the ceramic fluid mixture contained in the closed chamber is reduced.

The relative motion between the first half-mold and the second half-mold varies the volume of the ceramic fluid mixture.

Thus, unlike what occurs in conventional molds, the ceramic fluid mixture is not required to be continuously injected into the closed chamber, since the volume of the closed chamber is variable.

The moving device further enables pressing of the ceramic fluid mixture to be performed at the interior of the porous mold assembly.

This improves the homogeneity of the formed ceramic products and prevents the creation of interior regions which may contain water which during drying or firing may result in cracks or damage to the ceramic products.

With the invention, ceramic products can be obtained wherein a more uniform distribution of the humidity is present.

Such ceramic products consequently exhibit, during firing, a more homogeneous shrinkage and, after firing, a good finish.

A moving device or actuator may be provided such as to move the first half-mold away from the second half-mold for a distance sufficient for pouring the ceramic fluid mixture into the porous mold device in such a manner as to provide ornamental patterns in the ceramic products directly during forming.

The distance may for example be sufficient for enabling an anthropomorphous robot, or a distributing device the movement of which may be controlled over one or more axes, to lay in proper manner ceramic fluid mixtures of different colors, or different densities, so as to obtain an ornamental pattern including streaks, stripes or spots to provide an appearance similar to a natural stone on the ceramic products.

In particular, in order for a desired ornamental pattern to be obtained, it is possible to control the height and the inclination of one or more distributing nozzles of ceramic fluid mixture, the distributing flow rate and the moving speed of the distributing nozzles.

That enables a wide variety of decorations to be obtained.

The first half-mold and the second half-mold do not substantially modify the ornamental pattern when pressing the material contained in the closed chamber.

The amount of material deposited into the mold assembly is established so that a desired degree of compaction is obtained.

That is achieved by using a displacement pump that supplies the distributing nozzles, a control device which regulates the amount of ceramic fluid mixture that has been deposited by the distributing nozzles and a control device which regulates the density of the ceramic fluid mixture.

In a third aspect of the invention, an apparatus is provided comprising a porous mold assembly for forming ceramic products from a ceramic fluid mixture comprising a suspension of ceramic material in a liquid, the porous mold assembly comprising a first half-mold and a second half-mold, wherein the apparatus further comprises a pneumatic sealing device cooperating with the first half-mold and with the second half-mold for forming a chamber.

The pneumatic sealing device may be interposed between the first half-mold and the second half-mold.

Owing to the pneumatic sealing device, the chamber may be isolated from an external environment so that the ceramic fluid mixture does not flow out of the chamber particularly when the ceramic fluid mixture is pressed between the first half-mold and the second half-mold.

### BRIEF DESCRIPTION OF THE FIGURES

The invention can be better understood and carried out with reference to the enclosed drawings that illustrate some exemplifying and non-restrictive embodiments thereof, wherein:

FIG. 1 is a section of a porous mold assembly in an open configuration;

FIG. 2 is a section similar to FIG. 1, illustrating the porous mold assembly in a closed configuration;

FIG. 3 is an enlarged detail of FIG. 2, illustrating a sealing gasket of the porous mold assembly in a first operating configuration;

FIG. 4 is a detail similar to FIG. 3, illustrating the sealing gasket in a second operating configuration;

FIG. 5 is a partial sectional side view of an apparatus for forming ceramic products from a ceramic fluid mixture, illustrating the porous mold assembly of the apparatus in the open configuration;

FIG. 6 is a view similar to FIG. 5, illustrating a supplying device for laying the ceramic fluid mixture in the porous mold assembly;

FIG. 7 is a detail of FIG. 2, illustrating a pneumatic sealing element in a deflated configuration;

FIG. 8 is a detail view similar to FIG. 7, illustrating the pneumatic sealing element in an inflated configuration;

FIG. 9 is a partial cross section of a version of the porous mold assembly in the closed configuration in a first sealing position;

FIG. 10 is a section similar to FIG. 9 and shows the porous mold assembly in a second sealing position;

FIG. 11 is an enlarged view of a pneumatic sealing assembly provided in the porous mold assembly; and

FIG. 12 is a view similar to FIG. 11, illustrating an alternative version of the pneumatic sealing assembly.

### DETAILED DESCRIPTION

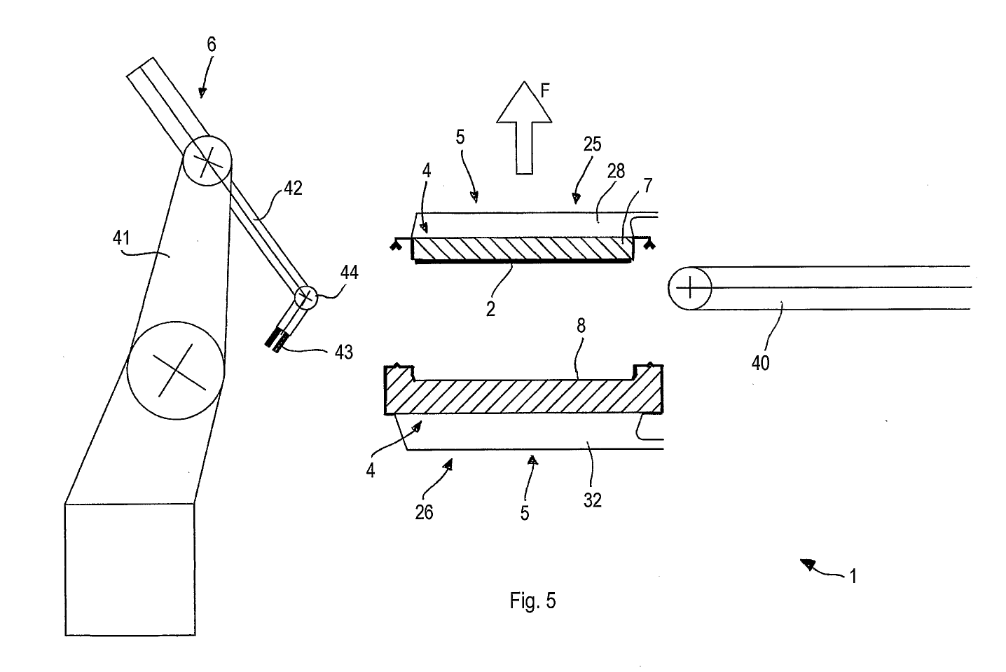

In FIG. 5 an apparatus 1 is shown for forming crude ceramic semi-finished products, in particular crude tiles 2, from a ceramic fluid mixture 3 comprising a suspension of ceramic material in a liquid.

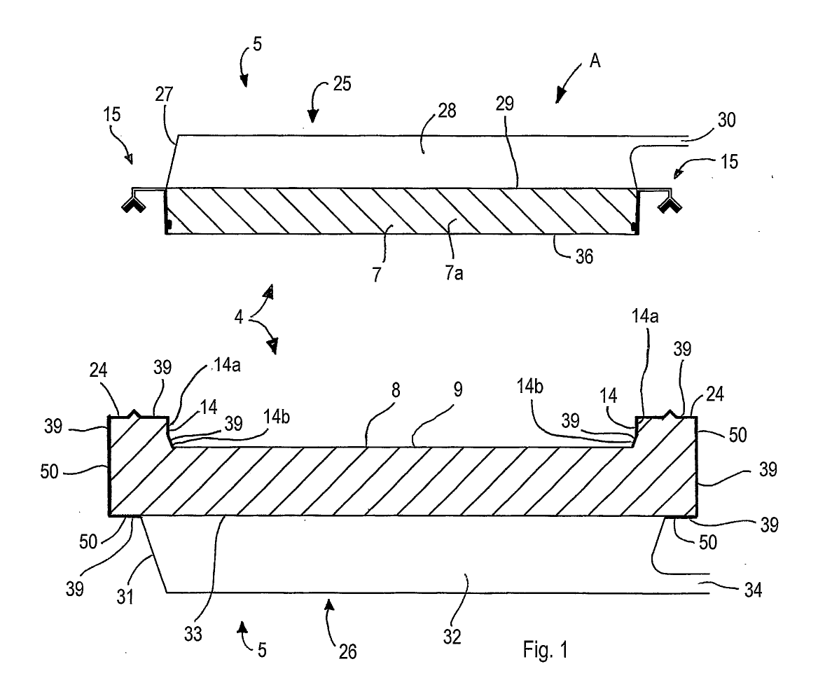

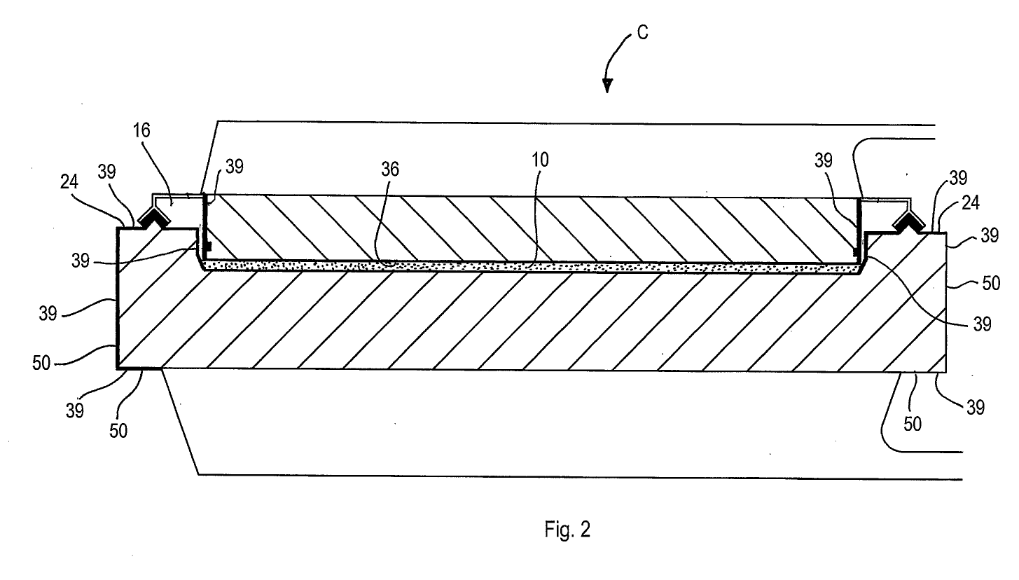

The apparatus 1 includes a porous mold assembly 4, a suction device 5, shown in the FIGS. 1 and 2, a moving device (not shown) and a supply device 6.

The porous mold assembly 4 includes a first half-mold 7 and a second half-mold 9.

The first half-mold 7 defines a male part, or punch, of the porous mold assembly 4, whereas the second half-mold 9 defines a female part, or die, of the porous mold assembly 4.

The first half-mold 7 includes a protruding portion 7a arranged for introduction within a cavity 8 of the second half-mold 9 so as to define a closed chamber 10 shown in FIG. 2.

The first half-mold 7 has a substantially rectangular plan profile and includes peripheral side walls 11.

Correspondingly, the cavity 8 also has a substantially rectangular shape and is arranged for accommodating the first half-mold 7.

The cavity 8 is peripherally defined by further side walls 14.

An upper portion 14a of the side walls 14 is substantially vertical, whereas a lower portion 14b of the side walls 14 is inclined slightly with respect to a vertical plane, for example by 1°, so as to form a draft angle that facilitates the extraction of a ceramic product from the cavity 8.

The porous mold assembly 4 further includes a sealing gasket 15 made of elastic material.

The sealing gasket 15 extends from an upper portion 12 of the side walls 11 over the whole perimeter of the first half-mold 7 to define a substantially rectangular frame and a further closed chamber 16 isolated from the external environment. The chamber 16 is defined by the first half-mold 7, the second half-mold 9 and the sealing gasket 15.

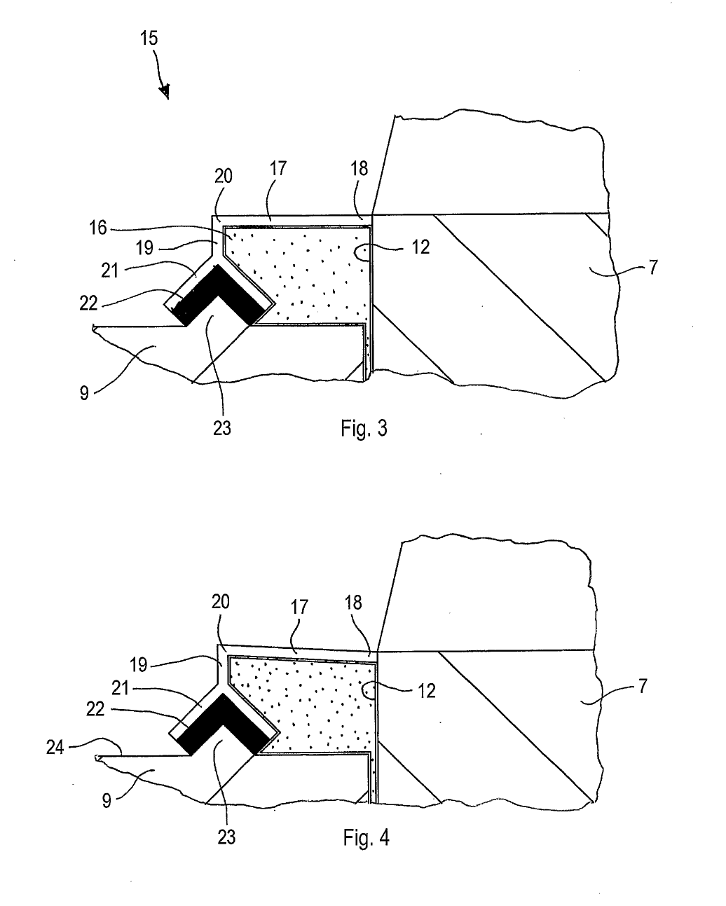

As shown in FIG. 3, the sealing gasket 15 includes a first substantially horizontal wall 17 connected along an internal edge 18 thereof with the upper portion 12 of the side walls 11.

The sealing gasket 15 further includes a substantially vertical second wall 19 and projecting towards the second half-mold 9 from an external edge 20 of the first wall 17.

A lower edge 21 of the second wall 19 is configured like an upside down V and is connected with a closing element 22 also profiled like an upside down V.

The closing element 22 is arranged for engaging with a protruding element 23 having a corresponding contour configured like an upside down V and provided on an upper surface 24 of the second half-mold 9.

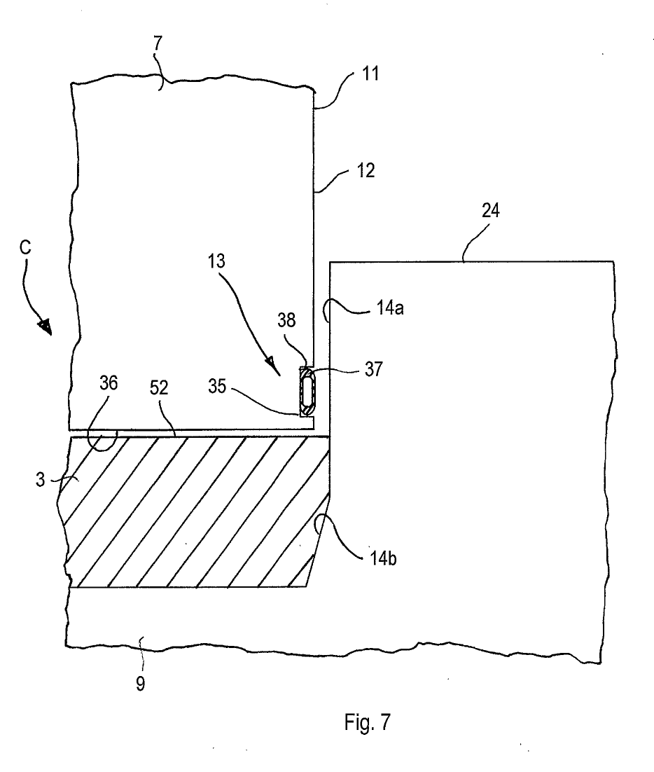

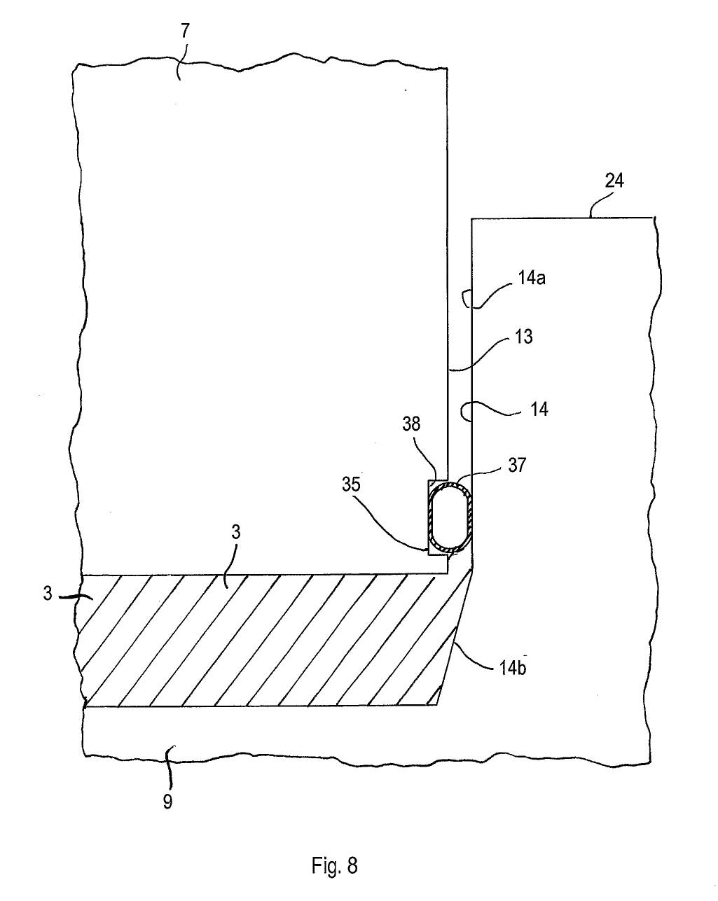

A lower portion 13 of the first half-mold 7 contains a recess 35 of substantially rectangular configuration as shown in FIGS. 7 and 8 that is arranged near a lower surface 36 of the first half-mold 7 and extends along the whole perimeter of the first half-mold 7.

The first half-mold 7 further comprises a pneumatic sealing element 37 arranged in the recess 35. The pneumatic sealing element may be connected with a bottom wall 38 of the recess 35.

The pneumatic sealing element 37 is formed of rubber or other elastic material and includes an air chamber that can be alternatively inflated as shown in FIG. 8 and deflated as shown in FIG. 7, by means of a pump, not shown.

In a version not shown, a lip laminar element is connected with the pneumatic sealing element 37, the lip laminar element being arranged for interacting with the second half-mold 9.

In a further version also not shown, the recess is provided in the second half-mold 9, rather than in the first half-mold 7.

The first half-mold 7 and the second half-mold 9 are made of porous material, for example a polymeric material and in particular, a polymeric resin. The pores are sized to be permeable to the liquid and the gas, but impermeable to the particles of ceramic material.

The porous material is obtained from an emulsion of organic components, polymerization liquids and a micronized inorganic charge, wherein water is present in small amounts together with properly selected surfactant agents. A catalyst agent produces polymerization, the consequent hardening of the organic components of the emulsion, and the formation of a solid material. The water present in small drops at the interior of the emulsion remains in the liquid state.

In other words, each water drop occupies a space where no polymerization reaction takes place.

Consequently, when hardening is terminated and water has been evacuated from the resulting solid material, this space forms a pore at the interior of the solid material. The obtained solid material appears then as a porous solid.

In order to produce the porous mold assembly 4, water must be uniformly dispersed from the interior of the solid material. Furthermore, it is important that the pores formed at the interior of the porous solid intercommunicate so that any pore is in direct connection with the surface of the porous mold assembly so that the assembly is as permeable as possible.

Consequently, owing to the porous mold assembly 4, liquid can be removed from the closed chamber 10 for example by applying a vacuum to a suction space positioned at a side of the porous mold arrangement 4 opposed to the side occupied by the closed chamber 10.

The porous mold assembly 4 is connected with the suction device 5.

The suction device 5 includes a first suction element 25 connected with the first half-mold 7 and a second suction element 26 connected with the second half-mold 9.

The first suction element 25 includes a first casing 27 defining a first suction space 28.

The first casing 27 is provided with a first opening 29 through which the first casing 27 is connected with the first half-mold 7 and with a second opening 30 through which the first casing 27 is connected with a suction device, not shown.

Similarly, the second suction element 26 comprises a second casing 31 defining a second suction space 32.

The second casing 31 is provided with a further first opening 33 through which the second casing 31 is connected with the second half-mold 9 and with a further second opening 34 through which the second casing 31 is connected with a further suction device, not shown.

The suction device and the further suction device are arranged for extracting or withdrawing a portion of the liquid present in the closed chamber 10 during formation of the tile 2.

The side walls 11 of the first half-mold 7, the further side walls 14 and the upper surface 24 of the second half-mold 9 are covered with a barrier material 39 which is impermeable to the liquid and air that entirely occludes the pores.

Also external surfaces 50 of the second half-mold 9, facing the external environment, are covered with the barrier material 39 for isolating the porous mold assembly 4 from the external environment.

In other words, only the surfaces of the first half-mold 7 and the second half-mold 9 that face the closed chamber 10, within the first opening 29 and the further first opening 33 are not covered with the barrier material 39.

In an initial phase of the process for forming the tile 2, a moving device or actuator maintains the porous mold assembly 4 in an open configuration A, shown in FIG. 1.

In the open configuration A, the first half-mold 7 is maintained at a proper distance from the second half-mold 9 so that the cavity 8 of the second half-mold 9 can be filled with ceramic fluid mixture 3, by means of the supply device 6.

In the initial phase, the pneumatic sealing element 37 is deflated and the air chamber does not protrude laterally from the recess 35.

That enables the first half-mold 7 to be introduced into the second half-mold 9 without friction being generated between the pneumatic sealing element 37 and the further side walls 14.

After a proper amount of ceramic fluid mixture 3 has been poured into the cavity 8, the supply device 6 is moved away from the region interposed between the first half-mold 7 and the second half-mold 9.

Successively, the moving device moves the first half-mold 7 so as to bring the porous mold assembly 4 in a closed configuration C shown in FIG. 2, wherein the lower surface 36 of the first half-mold 7 lies near a free surface 52, visible in FIG. 7, of the ceramic fluid mixture 3.

In the closed configuration C, the closing element 22 tightly engages the protruding element 23, as shown in FIG. 3.

Successively, the pump inflates the pneumatic sealing element 37 so that the pneumatic sealing element 37 comes into contact with the further side walls 14 along the whole perimeter of the second half-mold 9.

Thus, below the pneumatic sealing element 37, the closed chamber 10 is defined, within which the ceramic fluid mixture 3 is contained.

Above the pneumatic sealing element 37, a further closed chamber 16 is further defined, upwardly limited by the sealing gasket 15.

A further pump, not shown, introduces a pressurized fluid such as water (or other liquid) or air, or a mixture of water (or other liquid) and air, into the further closed chamber 16.

The pneumatic sealing element 37 separates the ceramic fluid mixture 3 present in the closed chamber 10 from the fluid present within the further closed chamber 16.

When the porous mold assembly 4 is in the closed configuration C, a further downward movement of the first half-mold 7 is made possible owing to the sealing gasket 15.

Actually, the sealing gasket 15 can be deformed as shown in FIG. 4 in order to maintain the further closed chamber 16 isolated from the exterior.

Successively, the moving device can move the first half-mold 7 further downward, so as to compress the ceramic fluid mixture 3.

The fluid present at the interior of the further closed chamber 16 is maintained by the pump at a pressure substantially equal to—or slightly lower than—the pressure of the ceramic fluid mixture 3 in the closed chamber 10.

Accordingly, the pneumatic sealing element 37 which separates two regions—i.e. the closed chamber 10 and the further closed chamber 16—at the interior of which very similar pressures are present, is not excessively deformed, assuring a good seal and a long service life.

While the ceramic fluid mixture 3 is compressed, the suction device 5 is activated and, through the first suction space 28 and the second suction space 32, extracts a part of the liquid from the closed chamber 10.

During the operation, the suction device 5 continues to extract liquid from the closed chamber 10 while the moving device moves the first half-mold 7 further downward.

In other words, the amount of liquid extracted or withdrawn through the porous mold assembly 4 is compensated by the reduction of the volume of the closed chamber 10.

The barrier material 39 arranged on the side wall 11, the further side wall 14 and the upper surface 24 prevents the suction device from extracting the fluid contained within the further chamber 16.

Conversely, the barrier material 39 arranged on the external surfaces 50 of the first half-mold 7 and the second half-mold 9 facing the external environment, prevents the suction device from withdrawing air from the external environment through the porous mold assembly 4.

During compression of the mold, the density of the ceramic fluid mixture 3 changes, since part of the liquid previously contained within the ceramic fluid mixture 3 is evacuated through the pores of the porous mold assembly 4, and the ceramic fluid mixture 3 is compacted.

The moving device continues to move the first half-mold 7 downwardly until the compacted ceramic mixture, after a prevailing fraction of liquid has been removed, becomes a crude semi-finished ceramic product such as a crude tile 2.

When the crude tile 2 has been formed, the second suction space 32 is placed under excessive pressure with respect to the external environment while the first suction space 28 is maintained under compression with respect to the external environment.

In this phase, in order to facilitate the mutual separation of the first half-mold 7 from the second half-mold 9, compression can not be generated at the interior of the closed chamber 16 with respect to the external environment.

In one embodiment, pressurized air can be directed into the closed chamber 16 for promoting the opening of the porous mold assembly 4.

The pneumatic sealing element 37 is deflated to allow mutual movement between the first half-mold 7 and the second half-mold 9.

Successively, the moving device raises the first half-mold 7, as indicated by the arrow F in FIG. 5, bringing the porous mold assembly 4 back to the open configuration A.

The depression present in the first suction space 28 is such as to maintain the crude tile 2 in contact with the lower surface 36 of the first half-mold 7 as shown in FIG. 5.

The crude tile 2 is consequently moved by the first half-mold 7.

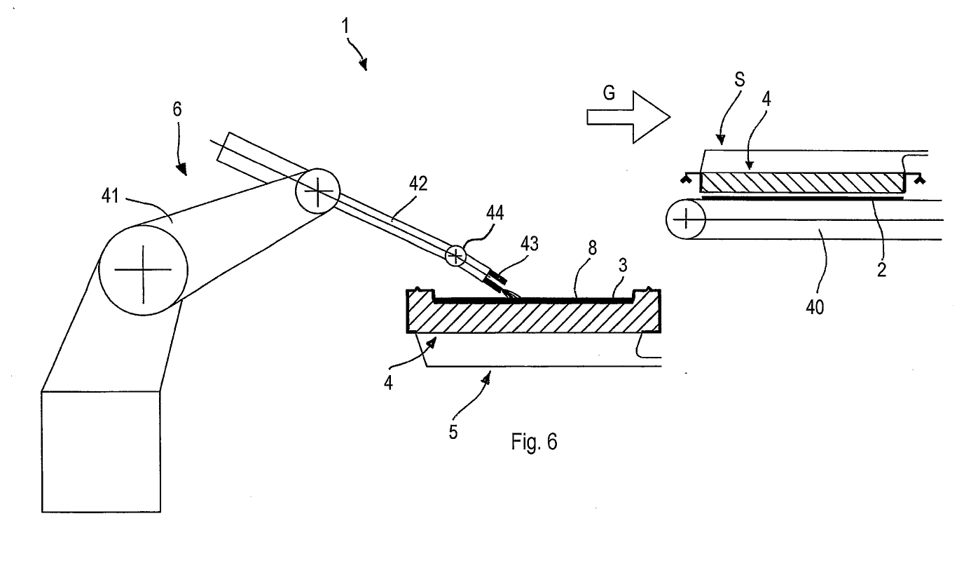

Successively, as indicated by the arrow G in FIG. 6, the moving device transfers the first half-mold 7, and thus the crude tile 2, over a conveyor belt 40 arranged beside the apparatus 1.

The first suction space 28 then equals the environment pressure and the crude tile 2 is laid down on the conveyor belt 40 which transports the crude tile 2 to a drying device.

While the first half-mold 7 is moved so as to lay the crude tile 2 on the conveyor belt 40, the porous mold assembly 4 is in the open configuration A and the apparatus 1 is again in the starting phase of the forming process.

Consequently, the cavity 8 of the second half-mold 9 can be filled again with the ceramic fluid mixture 3 by means of a supply device 6 and a subsequent working cycle can be started for forming a further crude tile 2.

The supply device 6 may comprise an anthropomorphous robot 41 provided with a moving arm 42—provided with a wrist 44—having a plurality of feeding nozzles 43 at one end.

The feeding nozzles 43 are arranged for pouring different types of ceramic fluid mixture 3 into the cavity 8 in order to decorate a tile directly during formation.

For example, in order to obtain streaks, stripes or spots, to provide an appearance similar to natural stone, different types of ceramic fluid mixture 3 can be laid.

The different types of ceramic fluid mixture 3 differ in density and/or color.

The more thick ceramic fluid mixtures 3 settle on the bottom of the cavity 8.

The less thick ceramic fluid mixtures 3 settle on the more thick ceramic fluid mixtures 3.

The manner in which the anthropomorphous robot 41 pours the different types of ceramic fluid mixture 3 into the cavity 8 establishes the final characteristics of the produced tiles.

For example, the final character of the produced tiles depends on the path covered by the moving arm 42 in order to pour the different ceramic fluid mixtures 3 into the cavity 8.

Also the flow rates provided by the feeding nozzles 43 contribute to different visual effects produced on the produced tiles.

The ceramic fluid mixture 3 is distributed by displacement pumps, not shown, connected with every feeding nozzle 43.

The displacement pumps are arranged for precisely metering amounts of ceramic fluid mixture 3 distributed by the feeding nozzles 43.

The feeding nozzles 43 have different dimensions and consequently, the flow rates distributed by the nozzles 43—and the effects obtained on the ceramic products are different.

Also, the height from which the different ceramic mixtures are poured affects the final character of the produced tiles.

In another version of the apparatus 1 not shown in the Figures, the conveyor belt 40 is moved substantially horizontally by means of a further moving device.

When the porous mold assembly 4 is in the open configuration A, the further moving device arranges the conveyor belt 40 below the first half-mold 7 so that the conveyor belt 40 receives the crude semi-finished ceramic product from the first half-mold 7 and transports the crude semi-finished ceramic product to a drying device.

In further versions of the apparatus 1, not shown, and operating according to the modes disclosed heretofore, the moving device moves both the first half-mold 7 and the second half-mold 9 or only the second half-mold 9.

The moving device is equipped with a controller that controls the stroke of the first half-mold 7 and/or the second half-mold 9.

The controller can detect a value of the torque of a motor driving the first half-mold 7 and/or the second half-mold 9 and regulate the stroke on the basis of the value.

Alternatively, the controller may comprise a sensor arranged for detecting a value of the pressure at the interior of the closed chamber 10 and regulate the stroke on the basis of the value.

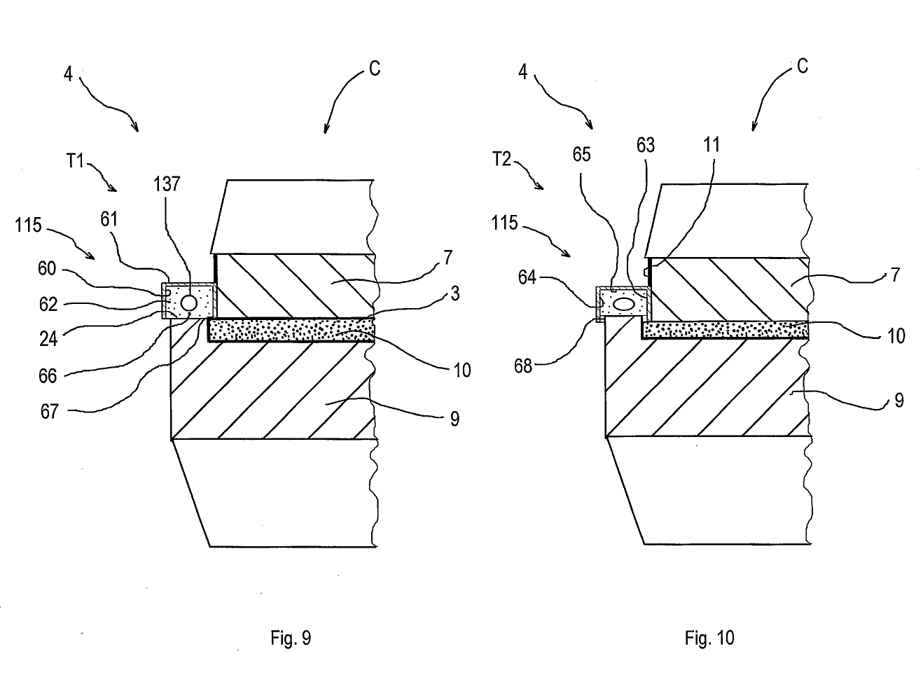

According to an alternative version shown in FIGS. 9 and 10, the porous mold assembly 4 comprises a sealing gasket 115 provided with a pneumatic element 137.

The sealing gasket 115 peripherally encloses the first half-mold 7 and defines a frame that, when the porous mold assembly 4 is in the closed configuration C, cooperates with the upper surface 24 of the second half-mold 9 for isolating the closed chamber 10 from an external environment.

The pneumatic element 137 is received in a housing 60 defined by a wall assembly 61 of the sealing gasket 115.

A resilient element 62 for example made of rubber at least partially encloses the pneumatic element 137 internally relative to the housing 60. The wall assembly 61 comprises a wall 63 and a further wall 64 that laterally defines the resilient element 62, and a still further wall 65 defining the resilient element 62 and connecting the wall 63 and the further wall 64. A portion 66 of the resilient element 62, arranged below the pneumatic element 137, is not defined by the wall assembly 61 and faces the upper surface 24 of the first half-mold 7 through an opening 67 of the housing 60. The sealing gasket 115 is fixed to side walls 11 of the second half-mold 9 by means of the wall 63.

The pneumatic element 137 is arranged substantially at the center of the resilient element 62.

Alternatively, the pneumatic element 137 may be arranged in a region of the housing 60 near the wall assembly 61. In particular, this region may be more distant from a central region of the porous mold assembly 4.

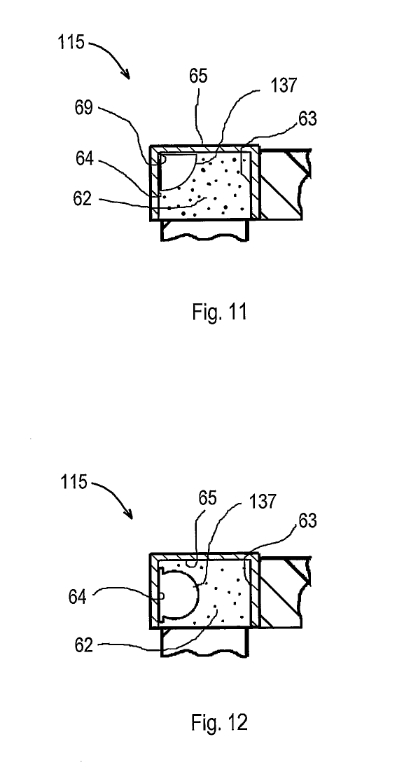

As shown in FIG. 11, the pneumatic element 137 may be arranged at an edge 69 of the housing 60, the edge 69 being defined by the further wall 64 and the still further wall 65. In this version, the connection of the pneumatic element 137 with the wall assembly 61 is particularly secure and durable.

Alternatively, as shown in FIG. 12, the pneumatic element 137 may be close to the further wall 64. In another version, not shown, the pneumatic element 137 may be close to the still further wall 65, and in particular may be arranged substantially near the center of the still further wall 65.

In a further alternative version, not shown, the pneumatic element 137 may be close to the wall 64.

The pneumatic element 137 comprises a tubular chamber, made of rubber for example, into which a pump not shown, may introduce a gas, such as air.

Feeding ducts, not shown, connect the pump with the pneumatic element 137. The feeding ducts, which may be external to the porous mold assembly 4, more easily reach the pneumatic element 137 in the versions where the pneumatic element 137 is closer to the wall assembly 61.

The pressure of the internal air of the pneumatic element 137 is regulated on the basis of the highest working pressure of the porous mold assembly 4, i.e. the pressure that, during the operation, the porous mold assembly 4 exerts on the ceramic fluid mixture 3.

In particular, the pressure of the air internally of the pneumatic element 137 may be substantially equal to the highest working pressure of the porous mold assembly 4.

Alternatively, the pneumatic element 137 may receive an incompressible fluid such as a liquid. In this case, a duct terminates inside the pneumatic element 137 for connecting the pneumatic element 137 with a receiver, so that the incompressible fluid can enter or exit the pneumatic element 137 depending on the force with which the first half-mold 7 and the second half-mold 9 are tightened against each other during pressing.

In particular, when the first half-mold 7 and the second half-mold 9 mutually interact to compress the ceramic fluid mixture 3, a part of the incompressible fluid flows from the pneumatic element 137 to the receiver through the duct, so as to compensate the variation of volume of the closed chamber 10 due to the evacuation of part of the liquid constituting the ceramic fluid mixture 3.

The tubular chamber may be an inner tube, in particular a reinforced inner tube of a cloth reinforced type. In this case, the pressure of the air, or the pressure of the incompressible fluid, substantially does not produce expansion in the pneumatic element 137 when the porous mold assembly 4 is not working, for example when the porous mold assembly 4 is in the open configuration A.

Owing to the pneumatic element 137, the sealing gasket 115 is deformable. When the ceramic fluid mixture 3 is pressed, the sealing gasket 115 passes from a first sealing configuration T1, shown in FIG. 9, wherein the sealing gasket 115 is not deformed, to a second sealing configuration T2, shown in FIG. 10, wherein the sealing gasket 115 is deformed.

An abutment zone 68 of the second half-mold 9, defined by the upper surface 24 is arranged to be received into the housing 60 during the operation of the porous mold assembly 4. The wall assembly 61 is adapted so that the wall assembly 61 can at least partially enclose the abutment zone 68.

During operation, when the porous mold assembly 4 reaches the closed configuration C, the portion 66 is in contact with the upper surface 24 and cooperates with the upper surface 24 for isolating the closed chamber 10 from the external environment. The sealing gasket 115 is in the first sealing configuration T1. The moving device moves the first half-mold 7 and the second half-mold 9 towards one another so as to compress the ceramic fluid mixture 3. The sealing gasket 115 moves to the second sealing configuration T2.

The sealing gasket 115 enables the volume of the closed chamber 10 to be reduced to compensate for the amount of liquid extracted through the porous mold assembly 4, even though the sealing gasket 115 maintains the closed chamber 10 isolated from the external environment.

Because the wall assembly 61 is substantially rigid, the pneumatic element 137 enables the resilient element 62 to be pressed by the upper surface 24 when the moving device moves the first half-mold 7 and the second half-mold 9 towards one another.

In a version not shown, the sealing gasket 115 may be fixed to the second half-mold 9 so that the opening 67 is oriented upwards. In this case, the first half-mold 7 is provided with an abutment zone against which the sealing gasket cooperates to define the closed chamber 10. The abutment zone of the first half-mold is received in the housing 60 compensate for the reduction of volume of the closed chamber 10.

1-33. (canceled)

34. A porous mold assembly, comprising:
a. first and second porous half-molds;
b. means for displacing said half-molds relative to each other, said half-molds defining a chamber as said half-molds are brought together, the volume of said chamber varying in accordance with the position of said half-molds, said chamber receiving a ceramic fluid mixture formed of a suspension of ceramic material in a liquid; and
c. suction means connected with said half-molds for drawing at least a portion of the liquid from the ceramic fluid mixture from said chamber via said porous half-molds, whereby a ceramic product is formed between said half-molds

35. Apparatus according to claim 34, and further comprising a pneumatic sealing device arranged for isolating said chamber from an environment external to said chamber.

36. Apparatus according to claim 35, wherein said pneumatic sealing device comprises a resilient element connected with said first half-mold arranged for cooperating with a surface of said second half-mold.

37. Apparatus according to claim 35, wherein said pneumatic sealing device comprises a tubular pneumatic element suitable for receiving an operating fluid.

38. Apparatus according to claim 37, wherein said operating fluid comprises an aeriform.

39. Apparatus according to claim 37, wherein said operating fluid comprises a liquid.

40. Apparatus according to claim 39, wherein said pneumatic sealing device further comprises a duct leading into said tubular pneumatic element and arranged for enabling said liquid to enter and exit said tubular pneumatic element.

41. Apparatus according to claim 37, wherein said pneumatic sealing device comprises a resilient element connected with said first half-mold arranged for cooperating with a surface of said second half-mold and said tubular pneumatic element is at least partially surrounded by said resilient element.

42. Apparatus according to claim 36, wherein said pneumatic sealing device further comprises a housing in which said resilient element is received.

43. Apparatus according to claim 42, wherein said housing comprises an opening for receiving a portion of said second half-mold.

44. Apparatus according to claim 43, wherein said surface is provided in said portion of said second half-mold.

45. Apparatus according to claim 42, wherein said housing comprises substantially rigid walls connected with said second half-mold.

46. Apparatus according to claim 35, wherein said pneumatic sealing device is arranged between said first half-mold and said second half-mold.

47. Apparatus according to claim 46, wherein said pneumatic sealing device may have a deflated configuration in which said pneumatic sealing device enables said first half-mold and said second half-mold to move with respect to one another, and an inflated configuration in which said pneumatic sealing device sealingly closes said chamber.

48. Apparatus according to claim 46, wherein said pneumatic sealing device comprises a tubular element associated with said first half-mold or said second half-mold and is provided with a lip element arranged for interacting with said second half-mold or with said first half-mold, respectively.

49. Apparatus according to claim 46, wherein said pneumatic sealing device is received within a groove contained in a peripheral portion of said first half-mold or in said second half-mold.

50. Apparatus according to claim 49, wherein said groove is arranged in a protruding portion of said first half-mold, said protruding portion being received in a cavity of said second half-mold.

51. Apparatus according to claim 46, and further comprising a sealing device cooperating with said first half-mold and with said second half-mold for defining a further chamber in said porous mold assembly, said further chamber and said chamber being arranged at opposite sides with respect to said pneumatic sealing device.

52. Apparatus according to claim 51, wherein said sealing device comprises a sealing element fixed to said first half-mold or said second half-mold and shaped to sealingly interact with a corresponding engaging element associated with said second half-mold or said first half-mold, respectively.

53. Apparatus according to claim 52, wherein said sealing element is connected with said first half-mold or said second half-mold through a deformable connecting element enabling said first half-mold and said second half-mold to move reciprocally after said sealing element has interacted with said engaging element.

54. Apparatus according to claim 51, and further comprising a supply device arranged for introducing a fluid into said further chamber and for withdrawing said fluid from said further chamber.

55. Apparatus according to claim 34, wherein said porous mold arrangement is made of polymeric material.

56. Apparatus according to claim 55, wherein said polymeric material is a polymeric resin.

57. A method for making ceramic products, comprising the steps of:
a. pouring a ceramic fluid mixture formed of a suspension of ceramic material in a liquid into a porous mold assembly;
b. extracting at least a portion of said liquid through said porous mold assembly; and
c. pressing said ceramic fluid mixture by reciprocally moving a first half-mold and a second half-mold of said porous mold assembly toward each other.

58. Method according to claim 57, wherein said pouring step comprises depositing said ceramic fluid mixture into said first half-mold or into said second half-mold when said first half-mold and said second half-mold are spaced apart, and after said depositing step, reciprocally moving said first half-mold and said second half-mold towards one another for defining between said first half-mold and said second half-mold a chamber.

59. Method according to claim 58, wherein said pressing step comprises further moving said first half-mold and said second half-mold together for reducing the volume of said chamber.

60. Method according to claim 58, wherein at least one of said moving and said further moving steps comprises introducing a protruding portion of said first half-mold or said second half-mold into a cavity of said second half-mold or said first half-mold, respectively.

61. Method according to claim 58, and further comprise during said pressing step, the step of deforming a pneumatic sealing assembly arranged for isolating said chamber from an environment external to said chamber so as to compensate for a variation of volume of said chamber.

62. Method according to claim 58, and further comprising during said pressing step, the step of inflating a pneumatic sealing assembly arranged between said first half-mold and said second half-mold for sealingly closing said chamber.

63. Method according to claim 62, and further comprising during said pressing step, the step of supplying a further chamber of said porous mold arrangement with a fluid, said further chamber and said chamber being arranged at opposing sides with respect to said pneumatic sealing assembly.

64. Method according to claim 62, and further comprising after said pressing step, the step of reciprocally moving away said first half-mold and said second half-mold, and before said moving away step, deflating said pneumatic sealing assembly.

65. Method according to claim 57, wherein said porous mold assembly is made of polymeric material.

66. Method according to claim 65, wherein said polymeric material is a polymeric resin.
